(19) United States
(12) Patent Application Publication
(10) Pub. No.: US 2007/0181072 A1
(43) Pub. Date: Aug. 9, 2007

(54) INTEGRATED SYSTEM OF SHELLFISH PRODUCTION AND UTILIZATION #2

(76) Inventor: Russell Patton Davis, Virginia Beach, VA (US)

Correspondence Address: RUSSELL P. DAVIS, 1521 QUAIL PT. RD., VIRGINIA BEACH, VA, 23454, US

(21) Appl. No.: 11/307,380

(22) Filed: Feb. 3, 2006

(51) Int. Cl. A01K 61/00

(52) U.S. Cl. 119/208

(57) ABSTRACT

The most fundamental measure of production constraint faced by the shellfish and coastal restoration industry is shellfish reproduction success as measured by the quantity of spawn surviving to maturity. SOLUTION: This is addressed with a novel device (FIG.2) and processes that economically increase the quantity of spawn tendered and the surviving quantity. The result is a now realizable, thus newly utilitarian, product with an intermediary product. The “INTEGRATED SYSTEM OF SHELLFISH PRODUCTION AND UTILIZATION#2” advances the economy, utility and scale of shellfish culture such that ecosystem restoration is now cost effective and terra-forming uses of shellfish culture can substantially supplant dredging, beach replenishment and foreshore erosion defenses.

### DESCRIPTION

The “INTEGRATED SYSTEM OF SHELLFISH PRODUCTION AND UTILIZATION#2” advances the economy, utility and scale of shellfish culture such that ecosystem restoration is now cost effective and terra-forming uses of shellfish culture can substantially supplant dredging and beach replenishment. One design feature unifying both the products and the processes of the system is an enhancement to the simplex optimization algorithm wherein the strategies developed by various species to optimally solve life's problems under particular environmental conditions and community dynamics are extracted, generalized and applied by means of human mediated cultural intervention to other species whose prosperity is desired even though current environmental and community conditions do not match the preference of the desired species. Thusly enabled the desired species can prosper ‘normally’ when normal is defined within the geological time frame in which the species became established. Thusly enabled, pioneer species can sequentially advance community development and succession such that biomass density and resource utilization are maximized. This result is of great economic and ecological utility. The current field of endeavor is shellfish within the aquatic and marine environment. Given maturity of expression the endeavor can be an example to be further generalized so that humans may know how to competently wage prosperity in addition to competently waging war. It appears that shellfish and subaquatic vegetation have been perfecting macroeconomics much longer than we have.

Resulting physical design features of the process devices in the system have unity in that they are an extraction and generalization of the reproductive strategy of unionoid mussels as inspired by intelligence of the unionoid mussels themselves in appropriating the gills of passing fishes as a replacement and mobile marsupium that serves when the mother mussel's marsupium becomes too small and not mobile enough to serve. The most significant of the process devices are mere reconfigurations of the amazingly intelligent behavior by these “lower” species. The most significant of the resulting new products are merely extrapolations of the community interactions of these “lower” species into conditions that add value to the human experience and marketplace.

### SPECIFICATION-BRIEF INTRODUCTION TO THE INVENTION AND ITS CONTEXT

The industry of shellfish aquaculture is in its infancy when measured against its potential. Recent cultural practices do not repopulate one half of one percent of our coastal bottomiands. This Invention, the “Integrated System of Shellfish Production#2”, will initiate a dramatically metamorphosization of the industry so it may achieve its potential to restore the health and productivity of our coastal waters. This invention has the breadth of application and readiness to scale that makes repopulation with the full cohort of shellfish species economically expedient. The feedback loops that define our waterway's ecological vitality and diversity no longer need to be constrained by the lack of niche services that can be provided by the full cohort of shellfish species. As those constraints are lifted many waters that are mildly polluted with ‘excess’ nutrients will find that the nutrient inputs are no longer excess. The load of residual pollutants will also become less significant in proportion to the increased biomass of the ecosystem as the ecosystem is matured into a more normal condition when seen in a geological time frame. Because the environmental need is much greater than the shellfish market depth (at this point in time) strategies to match the volume marketed to the market's desire are disclosed in PCT/US203/003997-otherwise the market would dictate that most of environmental requirement and much of the opportunity for production economy would not be economically feasible. Without a well-structured restraint on the growth of the quantity supplied to the market opposition to this inventions deployment would arise merely because the price of shellfish would be overly reduced by the growth in supply. This opposition expresses itself under a number of deceptive guises, the most common of which is a conceit to imaginary damage to imaginary scenic easements by a person with a profession like insurance agent who wishes to please a local shellfish baron. Given the ‘top neck hard clam market's price inelasticity of demand (price drops by more than 10% if quantity supplied increases by 10%) some of that deceptive and dishonorable opposition is inevitable. In Virginia USA opposition is expressed with systematically felony. Even so, it seems that luddites and their bagmen rarely prevail even if they do have a ten million dollar per year cash cow to protect. Given the effectiveness of this integrated system it is eventually inevitable that our waters may be husbanded such that the average annual production of seafood can approach the average productivity of a soybean field. On a wet weight basis, that is about ten thousand pounds of seafood per acre per year. That feasible goal of the upper boundary to potential is such a far cry from the aquatic deserts that most watermen and marine ecologists experience that this objective of this invention will be read by some as cruel mock of their hearts desire. Not so. This invention emulates the physiological and behavioral devices proven effective in the course of evolution. The leverage that this system gives shellfish culture is such that a six man hatchery operation may seed one hundred square miles per year such that the shellfish predators can be feed to satiation and still have enough surviving shellfish to occupy their niche. This is truly meets the requirement for novelty (“To change the form or proportions of a machine or manufacture such that a new mode of operation or function results”).

This invention is the result of a vigorous and recursive threshing of the full range of constraints on shellfish production against the array of strategies made effective against those constraints by the evolution of various species. Some quite fundamental constraints are relaxed enough to achieve a thousand fold increase in economy over common practice in shellfish culture.

Hard Clams, Surf clams and Rangia Clams and their like kinds are the pioneer species in the restoration of our coastal ecosystems. Much of the restoration is achieved by such a large scale increase in biomass that the mass of residual pollution becomes much less proportionally significant.

The design process that produced the array of features claimed in this “Integrated System of Shellfish Production and Utilization” was a reiterative variation of the simplex optimization algorithm where ranking assessments were substituted for hard numbers. For each operational node (step, stage, or obstacle) in the process an enumeration was made of the physiological or behavioral strategies that were used by some species or community of species to address the node; an array of devices to emulate each node:strategy was made and a marginal contribution (=marginal revenue minus marginal cost) ranking assigned to each operational node:device on a range of implementation scales; then the whole system of ‘rankings’ was reevaluated according to the marginal contribution of each operational node:device:scale as tempered by community interactions. The contribution margin ranking of each operational node:device:scale faces a subsequent cascade of constraints at each node along the production process. As each node is optimized another node becomes most significant in turn. Sometimes after a operational node:device is optimized its cost at a particular scale is such that the most cost significant node is a predecessor of the current node rather than a subsequent and the optimization process recurses. Sometimes that recursion only occurs at a particular scale or species. Sometime that recursion was only possible if a new use for shellfish production was introduced, such geophysical feature development or breeding for flexible immune competencies under environmental variation.

My processing of the algorithm was as disciplined as possible for me to achieve—it might be best described as ten years of diligent rumination on an ever expanding problem domain.

To my surprise, on the edges of that rumination I have found that the ruling constraints to shellfish production were more political than innately geophysical or biological. Even these political constraints can be relaxed and are addressed by devices in “The Integrated System of Shellfish production and Utilization”. The political, legal and market structure aspects of shellfish production have increasingly risen as bounds to my exploration of the problem domain.

The claimed features of the invented integrated system are not independent inventions subject to patent division but are connected by “design, operation, and effect” and consist of “a product, a process for making the product and an apparatus specially adapted” where the combined lower cost of production and the production problems resulting from production success requires dovetailing of production with ecosystem processes such that new product and intermediate product is required to continue process optimization. The “claims are linked to form a single innovative concept”. Take note that should the intellectual fatigue of a US patent examiner inspire a call for division of the application the following law is applicable:

DECLARATORY DECREE #11: “It is also the understanding and declaration of this jury that the US Code of Federal Regulations contains: “CFR Title 37 § 1.142 Requirement for restriction. A) If two or more independent and distinct inventions are claimed in a single application, the examiner in an Office action will require the applicant in the reply to that action to elect an invention to which the claims will be restricted, this official action being called a requirement for restriction (also known as a requirement for division).” It is also the understanding and declaration of this jury that this duly authorized regulation specifically states both “independent and distinct”. When an agent of the sovereign chooses to execute that law as either independent or distinct “they commit a conceit of authority that is a VA§18.2-481(5) felony. When committing such a criminal conceit of authority in Virginia the agent exposes their personal capacity to civil and/or criminal remedy under VA§18.2-481(5) as the criminal's honorable office can never commit treason against its sovereign. Moreover, such a crime harms a citizen's equity interest in their sovereign.”

### SPECIFICATION-APPARATUS OVERVIEW-STATEMENT OF THE INVENTION

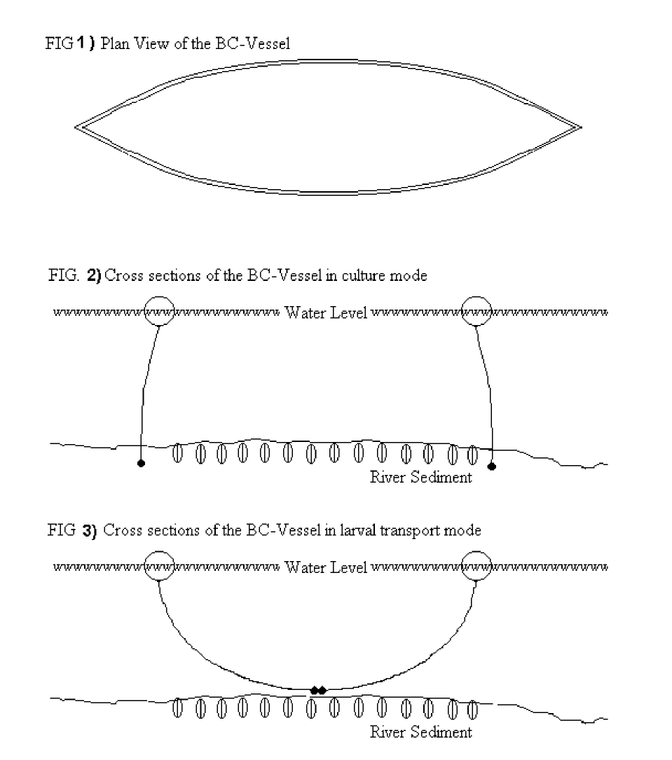

One very significant alternative to prior art enabled by the BC-Vessel variant (FIG. 1) is to permanently bed the shellfish in a shallow, sheltered, high productivity location in their natural environment, yet have the ability to easily contain the shellfish and their culture waters when need be (FIG.2). Given the estuary phytoplankton and temperature conditions expected in Virginia a BC-Vessel will probably be deployed for ten days per batch. Should the food plankton naturally available in the gonad conditioning season be inadequate or inappropriate the walls may be deployed so the food plankton may be cultured to feed to the shellfish. When spawning and larva-culture is complete, the BC-Vessel wall may be moved so the breeding stock is return to natural conditions with minimal stress to the breeding stock and minimal cost to the operator.

The BC-Vessel is a cultured water containment vessel with open top and sometimes open bottom (FIG.2) made of a reinforced vinyl membrane(FIG. 4A & FIG.6A) having ballast and anchor points on its bottom edge and inflatable float on its top edge(FIG. 4 & FIG.6). The bottom may be closed, enabling the BC-Vessel to transport larval clams for distribution (FIG.3). The BC-Vessel's transport utility earns it the legal treatment that all vessels receive.

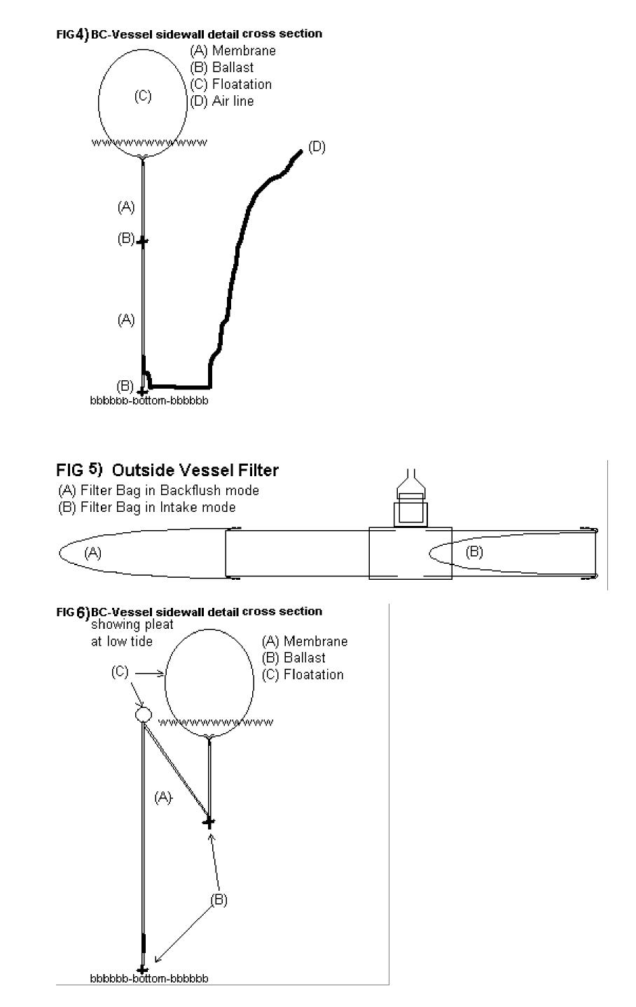

On deployment, the enclosure envelope is unrolled over the shellfish bed, ballast(FIG.4B & FIG.6B) inserted in the ballast pockets or attached ay the ballast ties, the anchor tie-lines tied and the floatation tube inflated(FIG.4C & FIG.6C) with an air hose (FIG.4D) inserted in a sleeve glued to the membrane extending from the bottom ballast to the floatation tube such that excess pressure may escape through the sleeve. The enclosure envelope is deployed with the two opposing sides of the enclosure touching each other. Water is pumped in between the two opposing sides to facilitate the opening of the enclosure so that it can encompass the bed of breeding stock shellfish. The pumped water is filtered to exclude most zooplankton. The initial opening of the enclosure may only be large enough to encompass the breeding stock to be spawned (FIG.2), if spawning induction is to be immediate. Water may be pumped into and out of the enclosure to match the change in tides and to ensure a sufficient quantity of fresh food laden water for the breeding stock to demonstrate their comfort with feeding behavior and feces excretion. Spawning in the BC-Vessel is induced by the introduction of visibly milky spawn water that may be conveniently produced using the conventional practice of thermal induction on a spawning table. By means of a movable vinyl partition in the BC-Vessel that is constructed like the side walls of the BC-Vessel(FIG.4), spawn density of the water in the BC-Vessel may be maintained at a density sufficient to trigger the further spawning of breeding stock with ripe gonads. Shellfish spawn with unmistakable exuberance. The water will become milky with spawn. The sidewalls of the BC-Vessel may also be moved to encompass additional breeding stock so that the visibly milky spawn water will trigger additional spawning. When the breeding stock has finished spawning additional filtered water is pumped into the BC-Vessel so that the BC-Vessel can be enlarged enough to meet the space needs of the larval shellfish during their planktonic phases. The enlargement of the BC-Vessel is generally made on the falling tide. Water is pumped into and out of the enclosure to match the union of the change in tides to the change in BC-Vessel enclosure dimensions, and also to ensure a sufficient quantity of fresh food laden water for the veliger larvae to prosper. That precision of that match is observed by the ingress or egress of unfiltered water around the bounds of the BC-Vessel wall where a perfect match will exert no force to move water around that bound provided the location hydrography matches the listed requirements and rough weather is not whacking the containment harder than anticipated during the BC-Vessel construction and deployment. The listed coping and recovery strategies with multiple sanctuary spawns per season manage and account for the weather risk inherent in any vessel based operation. The filters on the inside of the vessel have a large enough surface area (smooth, non- crenellated) with a cross surface current so that relatively few healthy shellfish veliger larva will become impinged on water pump-out. If the intersection the cross filter current, veliger swim rate, and through-filter pumping velocity is such the filter clogs with larvae then some change in operation is required such as 1) increasing cross filter current, 2) increasing filter surface area, or 3) decreasing pump out rate, 4) increase aeration or decrease the photoheterotrophic feed rate, or 5) decrease larval density with an early release. Observe larval swimming rates regularly. If the in-vessel filter is clogged with larvae having an abnormally slow swim rate they may be affected by excess CO2 or deficient O2 or food surplus or deficiency. Observe larvae gut condition and culture water dissolved gasses to determine the proper measure. The incoming-water travels through those same filters to achieve backflush. Back flushing bag filters (FIG. 5) serve on the outside of the vessel.

While large breeding stock clams may devote a larger portion of their food to gonad development than small, they typically do not transplant as successfully without special treatment. Those larger clams may not have needed to dig themselves into the sediment for many years. The transplant success rate is greatly improved by appropriately burying each individual clam that does not quickly bury itself. In terms of cost per million eggs, large chowders may be given a BC-Vessel treatment at a cost that is less than that of rehandled cherrystones that are traditionally used as breeding stock. Given the broader spread of ages in chowder clams it is also likely that chowder clams have greater genetic richness than cherrystones. Clams from a shifting sand environment appear to acclimate more readily to a new location and are most suitable for the initial trial operations. Restoration scale hatchery operations need to place genetic richness above many other considerations.

At recent market prices those survivors could have a wholesale value exceeding $500 million. The market could not gracefully absorb such a large harvest without dramatically depressing prices. The greatest portion of economic value achievable by those clams lies in the environmental services they offer the participating locality's waters and sub aquatic landforms.

The clam set's survival of predations is greatly influenced by the size of the set and the degree of predator satiation. To this end, it is of considerable value to maximize the size and synchronicity of the spawning events. Given the low cost of achieving spawn and the risk for cultural catastrophe at any subsequent stage of culture it is good economics to spawn and release many times more spawn than can be tended to setting maturity, given the dynamics of predation and competition within the large extent of the local ecosystem it is a more-is-better proposition. This size and synchronicity may be achieved at low cost using the chain-reaction method of spawn induction.

### DETAILED DESCRIPTION

Process with Representitive Required Resources

Spawner Sanctuaries: Will buy (or collect) and transplant some 560,000 breeding stock hard clams into duly sanctioned spawner sanctuaries where the clams' spawning may be managed for optimal effectiveness in reseeding _______ 's estuaries.

Genetic Resources:
Hopefully, at least 100,000 of the breeding stock will be of Local origin so that those particular genetic resources will not be overwhelmed.
Additionally, efforts will be made to acquire breeding stock from locations having conditions matching ______ Bay conditions.
Particular effort will be made to acquire hard clams that can prosper on muddy bottom. These clams usually have lighter shells so they won't die by sinking in the mud.
Particular attention will also be made to acquire breeding stock from salinities that match the target estuary.

Maximize Hard Clam Reproduction by using appropriate technology to decoupling optimization issues: Given:
the recent history of poor gonad development in portions of the ______ Bay (that appears to be related to recent low food qualities in the phytoplankton of those locations) and
the invention of techniques to move larva from locations where spawning and larvaculture can be successful to the locations where the larva set is needed to recondition that local environment;
Then the issue spawner sanctuary location and management can be decoupled from the larval settlement issue so those parts of the restoration process can (and should) be independently optimized.

Spawner Sanctuary optimization and location issues when larval settlement is decoupled from larval production:

Location: PORTFOLIO REQUIRMENT: The supply of food and water in the quality and quantity needed to condition gonads for the production of large quantities of spawn that have sufficient nutritional reserves to survive metamorphosis.
Typically located near ocean inlets where salinity is greater than 18ppt
Commonly, to achieve early gonad maturation, on the upstream side of a flat where the blush water accumulates on the flood tide, and
And Commonly, on the seaward side of marsh islands for controlled spawning due to a scarcity of summertime spawning cues; (not having a population of hard clams on adjacent flats that historically would have induced spawning in this adjacent location)

Timing PORTFOLIO REQUIRMENT: Timing of gonad condition is to meet a schedule of spawning induction and the subsequent tending of that spawn to optimize survival to settlement at the target settlement distributions. Achieved by matching the presence and timing of environmental timing cues at a sanctuary to the production schedule so that the environmental cues may be preempted by spawn induction as is needed to retain that spawn in cultural interventions needed to maximize survival to settlement in the target settlement distribution.

Parent Number per Sanctuary: The target number of parent clams in one sanctuary is that which will probably produce the quantity of spawn that can be tended by the larva cultural intervention. This number will determine the number breeding stock clams in a typical sanctuary (in which no other constraint intervenes). At present, it appears that the typical spawner sanctuary to be induced and cultured will contain 40,000 chowder sized spawners and produce 40 to 240 billion eggs per induction.

PORTFOLIO RISK DISTRIBUTION: Spawner sanctuaries should be distributed among diverse locations so that possible instances of adverse conditions will be unlikely to cause a failure of all larval production batches. A portfolio of locations having differing spontaneous spawning windows and differing times of gonad ripeness will aid in both work load spreading and recovery flexibility.

Topography and Layout: Spawner sanctuaries will have a bottom topography and layout that is conducive to the required spawn induction and larva-culture treatments.
Sanctuary water depth shall be shallower than −5 foot below MLW, with a significant portion near −1′MLW
The Sanctuary will have a serviceable access depth of 5 foot (for the hatchery vessel) within a distance of about 300 feet from the shallowest extent of the sanctuary (sized for BC-Vessel deployment).
that have a fairly uniform axis of ebb and flow with spring tide current speeds that match the strength of the BC-Vessel deployment: (the intersection of maximum spring tide current and a current-spin-inducing high off axis wind force currents is not likely to be accommodated in anyway other than deflating the BC-Vessel wall floatation with a full release of cultured water, such may not be optimal but still an early release success in that the “desired result inevitably follows” even if at a low success rate).
and have a modest wave exposure and be somewhat sheltered from wind induced currents that are off the normally uniform axis of ebb and flow,
and have an unobstructed bottom,
and have space and layout that can support the deployment of the culture vessels without creating any hazards to navigation or related risk or nuisance,
And do not have a significant population of breeding stock on adjacent flats that might accidentally induce spawning in the operation's spawner sanctuaries.
There are some estuaries which do not offer spawner sanctuary sites with both modest wave exposure and a uniform axis of ebb and flow. Should these estuaries be too potentially valuable to bypass BC-Vessels can be managed by a fortified array of anchors and/or large barge-like vessels grounded to provide adequate shielding from the waves and currents.

Ideally, the breeding stock clams will be well acclimated to their new location before they become fairly active in the spring when the water temperature rises above 60 degrees Fahrenheit. Delayed planting will tend to delay and/or decrease gonad development. Ideally, the breeding stock will be hand replanted. Many of the chowder sized breeding stock will not have had cause to rebury themselves for several years. It also appears that many of those clams have become incompetent due to such large size that their foot does not reach the sediment well enough to enable burial. Clams harvested from high-current, mobile sand environments will not need hand reburial. Unburied clams experience high levels of stress and frequently stop feeding when rocked by waves or impacted by vibration such as would be experienced prior to a predation event. A tight seal to deprive the predator of a scent target is established as a common coping strategy in hard clams. When the resulting nutritional incompetence is combined with the stress of temperature-rise induced gonad maturation, gonadal neoplasia (cancer) may result. Mortality can approach 100% in unburied clams on hard bottom with wave action.

Sediment characteristics influence sanctuary management.
Soft sediments allow clams to rebury themselves, but deep soft sediments can cause some clams to drown.
Turbidity over soft sediments can be a detriment to nutritional competence in that high pseudo-feces production has a cost in terms of the excretion of the binding mucus.
The turbidity over soft sediments can negatively impact the pump and filter portion of larvaculture interventions.
A few inches of loose, dense sediment over consolidated or dense sediment appears supportive of sanctuary management objectives. It is important that the sediment is not overly mobile.

The security of breeding stock within the sanctuary:
The breeding stock may be the property of the governing civil authority. Their sanctuary may be set aside and protected by resolution and community acclaim.
Bottoms that are uncertified for harvest maybe fine for spawn production. The uncertified status offers some deterrence to accidental poaching.
Sanctuaries that are close to bridges and marinas are protected by the observations of the community and the ready proximity of law enforcement personnel.
A steel grate submerged in the sanctuary sediment can obstruct commercial harvest by rake or dredge. A steel grate buried in the suboxic sediment can provide protection for a very long time and can cost less than ten cents per clam to implement. Bottom obstructions for this purpose were suggested by page 88 Of the Strategies and Recommendations for Revitalizing the Hard Clam Fisheries in Suffolk County, New York (SCPD 1987) This protection should, at the very least, be extended to the breeding stock that may contain irreplaceable genetic material.
A cell phone based electronic observation post capable of observing several sanctuaries in the dark is technically and economically viable given the value of the sanctuaries.

Brood Stock Gonad Conditioning: Natural
The selected locations for the spawner sanctuaries will have a relatively reliable supply of food phytoplankton that will arrive with the ocean waters on each flood tide.
That reliable, if not rich, food supply is typically sufficient to induce gonad maturation.
Given the scarcity of clams on the flats and behind the flats, the selected locations for the seaward spawner sanctuaries will typically not see conditions that induce spawning until the last-chance spawn during the fall temperature drop where the spawn would be released on the outgoing tide and probably lost to the colder estuary enclosure. The behavioral pattern common to these locations means that these clams will generally wait to spawn until spawning is induced by the BC-Vessel hatchery operation so the larval survival rate can be enhanced.

Brood Stock Gonad Conditioning: with Additional Food via slack tide BC-Vessel deployment
Should the food phytoplankton supply be so poor as to hazard spawning success or excessively delay maturation, the natural supply of food phytoplankton to the spawner sanctuary may be supplemented
The food phytoplankton supplement may be successfully directed to the in-situ spawners by encompassing them within the BC-Vessel for the lean water portion in the cycle of tides. Air will be pumped into and out of the BC-Vessel floatation as needed through a sleeve extending from the float to the bottom of the BC-Vessel wall. This sleeve allows excess air to escape so the floatation need not rupture. The collapsed and submerged BC-Vessel must have reef lines ties or stakes in order keep the BC-Vessel walls from over laying the brood stock. Additional ‘battens’ that are alternately made of ballast or floatation can make the walls largely self-furling much like the sails of a Chinese Junk.
A production maximum of 30,000 gallons per day Enhanced-Wells-Glancy/Seaweed-Soup feed water is anticipated. This prior art is disclosed in PCT/US203/003997. This maybe used to seed mesocosm culture of phytoplankton and insure proper distribution of the seaweed soup nutrients (much like thinning a gravy to avoid lumps).
BC-Vessel hosted mesocosm culture of phytoplankton and breeding stock: (see that section on page 19).
Phytoplankton culture could begin in late April for testing, tuning and for assuring an early supply of conditioned clams.

Spawn Induction: A cascade (“Chain Reaction”) of spawn induction may be reliability induced in hard clams with ripe gonads
Spawning events start very conventionally with 100 clams on the spawning table using thermal induction
Extending to 1000 clams in the on-deck spawning pool via a chain reaction from that spawn-water from the first 100 clams on the spawning table
and then extending to the 39,000 clams in the spawner sanctuary bottom where the spawn waters are kept from becoming so dilute as to extinguish the cascade of spawn by means of the BC-Vessel management.

The spawning batch target veliger production is 50 billion.
three million eggs average female
40,000 spawners containing
66% females: assuming a chowder sized population
80% fertilization success rate
The polyspermy problem in conventional aseptic hatchery operations is avoided by the estuary bottom hosting of the event where the normal population of benthic protozoa feast upon the excess number of sperm so that a more appropriate number effects fertilization
80% veliger survival to release
Batch larva culture completes at the pediveliger stage which is expected to be reached within ten days of spawning
14 batches, one every two weeks during June, July and August with the expectation that spawning may start in May and complete in September; resulting in the release of 700 billion larva .
   Annual Production Targets:
The Annual production target is the distribution of 266 billion pediveligers and 434 billion veligers over the 70,000 acres of the ______ Bay and ______ Estuaries. This production and distribution is intended to approach that which is normal for the restored estuaries.
A 99.9% predation rate from seeding to top neck is expected. This should be a very fat year for the predator species.
Survival rates from seeding-to-top-neck are expected to be a minimum of one tenth of one percent resulting in 700 million adult survivors.
Surviving top neck sized clams are expected to have a minimum population density averaging one every four square feet.

Low Density Veliger Culture-BC-Vessel—
Average Dimensions of 175′ by 300′ by 4 foot of water =>210,000CF=>1.6 million gallons=>6.4 million liters;
BC-Vessel—Open Bottom Deployment
In Situ Broodstock gonad condition enhancement—see section F6.
In Situ Spawn Induction—see section C.
Veliger Density Management Targets: Depending upon estuary food phytoplankton density the Target Pediveliger Density is around 3 per milliliter giving a target pediveliger batch size of 19 billion pediveligers
Veligers will be released daily as the veliger food requirements increase
The spawning of 50,000 breeding stock clams could produce 100 billion eggs with about 50 billion larvae that survive to be released, meaning that about 5 billion veligers per day would be released prior to the release of 20 billion pediveligers at the termination of the batch.
(16 150 GPM pump&filter sets=>13,000,000 L pumped/day (pumped in then pumped out for 6.5 million L/day exchange) on two pontoon boats 21′×10′ made of plastic barrels & barjoists
each pump may need to be refueled about six times per day (When time allows convert to One tank per pump boat with distribution lines)
giving each veliger at least two times the amount of fresh water compared to typical static water culture
Water will be pumped both in and out of the BC-Vessel through filters. The filters in the BC-Vessel are configured to minimize larval impingement on the filter surface. The minimization is achieved by
large filter surface area with
large cross-filter currents induced by large air bubbles.
Large cross-filter currents from induced water circulation such as could be provided by motorboat drive when anchored within the BC-Vessel. The induced current may also used to oppose currents pressing against the outside wall of the BC-Vessel so that containment is possible in higher current conditions(spring tides and wind forced currents).
   Veliger Food Requirements:
(1) The 5 day old veliger's requirement of approximately 50,000 phytoplankton per day may be a challenge if estuary phytoplankton is below 50,000 isocrysis-equivalent per ml. Given 3 veligers/ml density and a 100% daily exchange only 33% of the required ration would be pumped in
(2) Cultured food phytoplankton maybe be added to the BC-Vessel at a maximum of 100,000 liters per day of EWG/Seaweed-Soup feed water to provide a fixed carbon equivalent of 600,000 isocrysis (sp?) per ML or 3,200 isocrysis equivalents per veliger on the 19 billion veligers. That is only 6% of a 50,000 isocrysis-eq/veliger/day ration.

Mesocosm culture of phytoplankton with the veligers in the 52,000 square foot opened BC-Vessel may grow the remaining of the veligers' daily food requirement (61% at 50,000 estuary phytoplankton/ml). This does appear possible considering the much lower grazing rates during the first three days of veliger culture that will allow for a bloom in the BC-Vessel provided that the exchange rates are reduced. The difference between high and low tide relative to the average depth of water in the BC-Vessel is the definition of minimum exchange rate as long as the area of BC-Vessel coverage is held constant. Provided that currents are sufficiently deflected by the hatchery mothership and the marsh island it may be possible to maximize mesocosm culture of phytoplankton within the BC Vessel by changing the locations of the BC-Vessel walls as the tide level changes so that cubic volume can remain relatively constant. Given a 4 foot average depth a one foot tidal range will require the vessel surface to vary (move BC-Vessel walls) by +/−12% or a 20 foot belly in two BC-Vessel walls having 300 feet between the anchored nodes This appears possible in a few locations. The management of BC-Vessel proportions to accommodate tidal change can be assisted by constructing the BC-Vessel wall so that it pleats at low tide (FIG.6). The creases on each pleat are assisted by a bit of floatation on one crease and a bit of ballast on the other crease. The forces applied by the pairing of floatation and ballast tend to fold the pleat so that the vertical surplus of BC-Vessel wall that exists at low tide will neither oppress benthic life nor block the sunlight needed to grow the feed phytoplankton. Alternatively, a context suitable arrangement of anchors, floats, ropes and/or elastic lines can pull the floating rim of the BC-Vessel outward as the tide ebbs such that the amount of captured sunlight is maximized. These management adaptations could be very important if estuary phytoplankton concentrations are scant.

Veliger gut inspections will have to be the authority guiding the BC-Vessel management since the estuary's assemblage of phytoplankton has variable quantity and palatability.

Required dry weight of seaweed to be rendered for photoheterotrophic culture of phytoplankton: The soup kitchen should have reserve capacity seeing how food limits the operation and given that when seaweed soup is substantial part of the balanced nutrient ration, phytoplankton divide as many as ten times per day or ten times the rate possible when the phytoplankton photosynthesis must fix all carbon. Soup kitchen capacity may be enhanced by the use of commercially available powdered seaweed (each source needs testing for acceptability to phytoplankton & clams).

Given a feed rate recommended by Borges and Enes of 0.7% dry weight algal ration per live weight clam (2.6 g per 375 g clam), 40,000 chowder-sized breeding clams have est. weight of 15,000 kg and could be prospered on a algal ration of 105 kg dry weight/day. This roughly equates to 26 kg of fixed carbon. In a BC-Vessel having 5800 square meters sunlit surface this equates to a combined photoheterotrophic carbon fixation and assimilation rate of 4.5 grams of carbon per meter square per day in.

Given
the unknown but expected high oxygen demand incumbent to assimilating 3.5 g carbon per day per meter square more that the 1 g C/d/msq fixed and
there being little need for a greater feeding rate at the expected density of clams and larva
Then the target BC-Vessel heterotrophic feeding rate should start around 1 grams carbon per day per meter square and be modified as needed, probably never exceeding 5 grams carbon per day per meter square
   Given
A chowder-size clam has a filtering and clearance rate of 100 liters per day and
an average BC-Vessel food concentration of 2.6 g dry algae˜=.65 g carbon per 100 liters (26 g dry algea/cubic meter˜=6.5 g C/cubic meter),
6.4 million liters in the BC-Vessel divided by 40,000 chowder-size clams is 160 liters capacity per chowder-sized breeding stock clam giving a once-thru-the-clam period of 1.6 days.

Given the phytoplankton's phototrophic division rate of once per day and the photoheterotrophic division rate of up to ten times per day it is reasonable to expect a mesocosm culture of the food phytoplankton in the BC-Vessel that will be more than sufficient to meet the needs of both the breeding stock and the larva.

Moreover the appearance of substantial reserve capacity (created via seaweed soup driven photoheterotrophic growth) means that the phytoplankton assemblages growth does not need to be driven so hard with the resulting high perturbation of the population composition.

Moreover the reduced pumping cost and labor incumbent to low water exchange rate can enable multiple deployments BC-Vessels for longer periods so that breeding stock gonad conditioning may be enhanced and the clams may encourage a more historically normal assemblage of phytoplankton species by minimizing nutrient pulses that give competitive advantage to the overly small (from a clam's point of view) phytoplankton with their large surface to mass ratios.

One advantage of this low-exchange-rate, mesocosm culture strategy is that it demonstrates how the once rich middle stretch of the Great South Bay NY can be made rich once again by the clams' influence.

Oxygen content of the BC-Vessel water can be managed in part by varying the ratio of the phytoplankton's of photoautotrophic carbon fixation to photoheterotrophic carbon assimilation within the context of clam sequestration of phytoplankton carbon. The seaweed soup densities can be delivered when BC-Vessel dissolved oxygen content is rising and made low at night to diminish phytoplankton respiration demand for oxygen. Given the process leads and lags, brief transients of oxygen scarcity in the early morning hours may be necessary to maximize phytoplankton production. Those brief transients may also be needed to induce the phytoplankton (and slime molds) to produce lipids(low oxygen content energy storage) as is needed in the clam egg to enable successful metamorphosis into the d-stage veliger. The presence of brief low oxygen transient and lipids would logically present the clams with a cue that their environment is rich with opportunities that can only be meet through reproduction. As the growing larva increase carbon sequestration the low oxygen transients due to insufficient grazing of phytoplankton should disappear.

Within this dynamic there is an apparent clam sedating effect of high CO2 levels that remains to be examined and managed.

Intense monitoring of the evolving physical chemistry of the mesocosm culture can be highly instructive both in terms of optimal culture management and optimal estuary management.
About 1250 k of fresh seaweed dries to about 250 k. Commercially available dry powdered seaweed would be much easier to ‘soup’ than fresh seaweed. Acceptable to clams & phytoplankton? Appears so but may be batch and source dependant.
Local seaweed may be dried and milled. One metric ton fresh seaweed input per day seems a bit arduous but still too little for economies of scale.
Fraga, Fernando: Phytoplankton biomass synthesis: application to deviations from Redfield stoichiometry SCI. MAR., 65 (Suppl. 3):153-169
Ryther, J. H.; Dunstan, W. M.; Tenore, K. R.; and Huguenin, J. E.:

Controlled Eutrophication Increasing Food Production From the Sea by Recycling Human Wastes. Bioscience, vol. 22, no. 3, 1972, pp. 144-152.
“With a food concentration as algal dry weight per total seed live weight of 0.7% day⁻¹, seed for grow-out (7 mm) could be obtained within 1 month” Evaluation of microalgae and industrial cheese whey as diets for Tapes decussatus (L.) seed: effects on water quality, growth, survival, condition and filtration rate
Aquaculture Research March 2003, vol. 34, no. 4, pp. 299-309 (11) Enes P.; Borges M-T.
Milton, R. F. 1964. Liquid seaweeds as fertilizers. Intl. Seaweed Symposium, Spain, 4:428-431
Culture of marine microalgae with natural biodigested resources Journal of Aquaculture & Aquatic Sciences Volume 5, Number 1
Aquaculture International 6 (4): 303-315, August 1998 Hatchery cultivation of Pacific oyster juveniles using algae produced in outdoor bloom-tanks
Sherr, E. B. 1988. Direct use of high molecular weight polysaccharide by heterotrophic flagellates. Nature 335:348-351
Haines, E. B. and W. M. Dunstan. 1975. The distribution and relation of particulate organic material and primary productivity in the Georgia Bight. 1973-74. Estuarine and Coastal Marine Science 3:421-441.
The breeding stock on the bottom under the veligers will also consume phytoplankton but it seems likely that they would be at a great competitive disadvantage to their veliger children so the breeding stock would largely serve in the clean-up crew for the approximately seven days of larvaculture.
If veligers appear to have empty guts, veligers may be released to improve food availability to the remainder

BC-Vessel - Closed Bottom Deployment (FIG. 3)
Conversion of BC-Vessel to closed bottom transport configuration
Pediveliger concentration by filtered water pump-out
Larval Release:
In Process release of veligers to maintain veliger gut condition of the remainder
Veliger/Pediveliger capture in filter bag via air lift for remote setting
Veliger/Pediveliger dispersion via BC-Vessel (tide assisted short distance tow for slack tide release)
Inlet side release at low tide
Upstream release at high tide

### DESCRIPTION OF THE PRIOR ART

The public domain contributions of South Carolina Sea Grant in their publications on Tidal-Powered Upwelling Nursery and Hard Clam culture were pivotal to the development of this design.

The public domain contributions of Harbor Branch Oceanographic Institution of Fort Pierce, FL, as offered in their Bivalve Hatchery course are also useful disclosures of typical prior art.

In recent years, a number of innovative aquaculture systems have been developed. Three examples of such systems include U.S. Pat. No. 6,024,050 to Rheault, issued Feb. 8, 2000 and U.S. Pat. No. 5,438,958 to Ericsson et al., issued Aug. 8, 1995 and U.S. Pat. No. 4,860,690 to De Santo et al., issued Aug. 29, 1989; and . The disclosures of the Rheault, Ericsson et al. and De Santo et al. U.S. patents are hereby incorporated by reference as are the enabling methods that are customary to the industry and represented in a publication of the South Carolina Sea Grant, “A Manual for the culture of the Hard Clam Mercanaia spp in South Carolina”.

One significant drawback of the aquaculture system disclosed in De Santo et al. resides in its utilization of tidal-powered baskets (in lieu of upwellers) to rear the shellfish. Such baskets allow the waters in and around the marine dock to flow about the shellfish seed being grown but the flow rate of the water circulating there through is necessarily limited by the natural conditions of the ambient environment. This natural flow rate is typically far too inadequate to permit rapid growth in high concentrations of shellfish seed during the nursery phase. Thus, De Santo et al.'s aquaculture system is prone to either low concentrations of shellfish seed or to stunted shellfish growth.

One way to alleviate the deficiencies in the De Santo aquaculture system is to use aquaculture upwellers (as in Rheault) in lieu of De Santo's baskets. Upwellers typically consist of a silo formed from a hollow cylindrical piece of PVC pipe and a screen assembly permanently affixed (typically glued) to one end of the silo.

The economic advantage in nursery operations is non-existent given the reduction in hatchery cost achieved and large scale achieved in this invention.

The high flow rate and high backflush frequency of the automatic back flush hatchery marsupiums in the prior art of PCT/US203/003997 made them vulnerable to clogging and mechanical failure with resultant mortality of the larvae. The relatively extensive, lower density, nature of the BC-Vessel hatchery operation avoids the extremity of these issues. In the BC-Vessel hatchery operation, technical glitches are more likely to just determine the timing of a partial larval release that will be needed in any case; technical glitches are much less likely to invoke a total batch failure.

The ten physical attacks on the Mama Cass hatchery vessel and the dozen or so VA§18.2-481(5) felony attacks are the necessity that provided a mother for this invention. That bit of criminality made it a near certainty that the big increase in production that the probable racketeer should fear will happen. This will certainly happen in a way that is most adverse if those crimes escalate to my murder. The overseas establishment of this patent will reasonably ensure the production increase even if I am not alive to do it myself. At least one Virginian had a multimillion-dollar per year incentive to suppress my operation. Perhaps, that person defended his turf with more reservation and scruple that his subordinates could tolerate. Historically it is common for kings to be deposed if they won't defend their territory. Chad Ballard died at home, at age 55, of unexpected ‘natural causes’ in October, 2004. At least one Ballard's subordinates would probably have known that a heart attack can be induced with a potassium chloride injection and that the evidence of the poisoning is largely erased by the process of death. The escalated and broadened attack by VA§18.2-481(5) felony since Ballard's death and the garbling of US Patent Office published records (partially transient) encourages me to suspect that Ballard's death was murder. It enhances the security of my property and my life to arrange things so that crimes against me do not stop the results of my invention. It appears that my inventions must emmigrate to multiple nations even if I don't.

In the common prior art the swarming strategies enabled by this invention were not economically feasible (no utility) so the shellfish culturists generally kept their management efforts and attention focused on the cultured species to the general exclusion of that specie's ecological context other than to suppress predation. Given the benefits of this patent, that narrow focus is no longer obligatory or even economic. The vitality and diversity of the whole estuary ecosystem benefits from the deployment of the swarming strategy so common in nature and made possible by this invention. The synchronized induction of spawning and the high density and extent of breeding stock that existed prior to modern history is recreated by the claimed process and device. The effect of shellfish and subaquatic vegetation upon the quality and quantity of the feed phytoplankton assemblage as it would have configured prior to the condition of modern history is emulated by the claimed process and device such that breeding stock gonad development is enhanced to provide a two to ten fold increase in spawn quantity as measured by viability thru metamorphosis. The device and process emulation of the density and extensiveness of prehistoric breeding stock is anticipated to achieve a hundred fold increase in fertilization success as compared to much of the currently existent breeding stock. The synchronization and season timing provided by the device and process prevents essentially the complete loss of most of the remaining assemblages' spawn in that those deeper water assemblages frequently do not appear to spawn until they receive low temperature cues on the outgoing tide that this is their last chance to spawn for the season.

There is no prior art for the “BC-VESSEL”. Both the device and their application are without president as devices of human construction (as opposed to species community evolution) within the human context of patent law the claimed advances is entirely my own novel invention.

The resource that initially constrained both hatchery and nursery nodes in the prior art was real estate with good and certain quality water.

The high cost and scarcity of land based operation space combined with water quality transients made vessel based operations obligatory if the need for scale and economy was going to be meet.

Suitably massive rigid vessels impose high fixed costs and violate draft, navigation or management constraints. The flexible, and practically disposable, BC-Vessel avoids these costs and constraints.

The most innovative features of this “INTEGRATED SYSTEM OF SHELLFISH PRODUCTION AND UTILIZATION#2” are products that never would have been invented so quickly were it not for the challenge presented by criminals. Just as the two-legged predators prompted the features and scale of the ‘swarm’ mode of operation that made the prior art of clam predator exclusion devices economically obsolete, that same sort of criminal behavior against the 2004 expression of prior art described in PCT/US203/003997 has been the necessity mothering this invention. The briefer the cultural intervention and the more massive and natural the water used in the cultural intervention the much less vulnerable to criminal attack and much quicker in recovery from attack. This recovery advantage applies equally to harm inflicted by bad weather or technical difficulty. The criminals have made the market position that they feared a near certainty by their crime. However, the scope of the crimes has broadened such that one party stands to gain some fifty million dollars as a result of the delay. The alternatives presented by the Canadian and UK patents of this invention and the structure of my will makes predation against my life and property anathema to the criminals' interests. It adds value to the patent and advances the intent of rule 9.1(ii) & (iv) that the criminals come to understand that their continued prosperity is only possible under the rule of law as advanced by means of this patent application.

The resulting scale of the invention made it obligatory to optimize the market dynamics as well as production and environmental dynamics. The model for this optimization was exemplified by the U.S. dairy industry and premium cheese industry. The features of crop insurance reserve and various environmental reserves make for an industry profile that can match the production exuberances needed for production economy, market development and environmental restoration while establishing the restraint required for orderly markets and resulting financial feasibility of marine environmental restoration.

Northern waters such as those of Newfoundland have produced relatively few hard clams and oysters in recent history. This is not so much because they do not grow there, but it is because of a scarcity of environmental cues inducing hard clams and oysters to spawn. This invention removes that constraint by providing large-scale hatchery services. The market advantage bequeathed by this traditional constraint on production is that that the market-ready shellfish will almost always be creamy rich and eager to spawn. Canada will produce the premium product. To maximize its net income Canada must significantly limit its export marketing to the service of that premium market. The international presence of this patent allows a legal structure in which that can happen. The Canadian province of Newfoundland is intended for the receipt of a joint, inalienable, prorate interest in the international expression of this invention.

The Caribbean Turks & Caicos Islands have a shellfish hatchery tradition of culturing uncommon or endangered species and creating a market for them. The combination of human and environmental resources is very rare and valuable. The Government of the Turks & Caicos Islands is intended for the receipt of a joint, inalienable, prorate interest in the international expression of this invention.

The Government of Montserrat is intended for the receipt of a joint, inalienable, prorate interest in the international expression of this invention (subject to conditions). Given its volcanic activity Montserrat is uniquely qualified as a living laboratory to reveal the dynamics behind community development and succession leading to community richness and productivity.

As a condition to this receipt, the bulk of profit is to be dedicated to the educational endeavors of Newfoundland, Turks and Caicos and Montserrat. It is my hope that Montserrat will establish a university that specializes in using the knowledge gained from its marine environmental work as a model to understand human community development and succession so that our future leaders will be well equipped to wage peace. Local profits are to be locally retained. Local profits are to be measured by local exports which includes the province/state exports of corporations owned by license holding citizens of these three prospective beneficiaries.

I, Russell P Davis, the inventor retains the remaining interest in the international expression of this invention to be used in Virginia, USA, provided the local tradition of racketeering by means of felony is stopped with particular emphasis on stopping the felony of, “resisting the execution of the laws under the color of its authority”.

The intended details of this implementation are to be handled democratically by the four votes from Newfoundland, Turks and Caicos, Montserrat and the estate of the inventor, Russell P. Davis.

These four entities are to be the voting members of a member corporation “The Coastal Restoration Institute and Marketing Cooperative (CRI)”. I hope that the voting members will find cause to base this institute in Montserrat.

The huge amount of shellfish in the CRI marketing cooperative ‘reserves’ will significantly discourage excess investment in the industry by high cost producers (without patent license). US license will probably be limited to one state that provides a good rule of law to support production. Canadian license will probably be limited to one province, Newfoundland. The geography and recent history of Newfoundland causes it to appear ideal at this point.

The breed-by-the-billion capability also advances the opportunities for larval selection for flexibility in immune competence as disclosed by PCT/US203/003997. The resulting breeds may be patented in turn. The longevity of competitive advantage had by the host province can be advanced by the coming sequence of breed patents. That combined with the development of a comparatively advanced distribution infrastructure due to the high volume of production can grant the host province/state a dominance in the industry that will endure beyond the life of this patent.

The polyculture disclosed by PCT/US203/003997 is further advanced by this invention in that many guild or cohort species will be cultured and spawned simultaneously with the target species whether intentional or not. The estuary-wide benefits of such massive spawning operations disclosed by PCT/US203/003997 is further advanced by this invention.

Oyster restoration benefits incidental to such massive spawning operations disclosed by PCT/US203/003997 are now made realizable and thus given utility by this invention.

Sea grass restoration benefits incidental to such massive spawning operations disclosed by PCT/US203/003997 are now made realizable and thus given utility by this invention.

Terra-forming benefits of such massive spawning operations are now made realizable and thus given utility by this current invention. Huge populations of Donax, Spisula and Mercenaria-like clams to help build and defend the beach foreshore and off shore bars and thereby provide collateral benefits to adjacent inlets by reducing the influx of sand along the bottom of the inlet flanking flood channels and retarding long-shore sand transport during erosion events. The vast number of small clams increase fine sand capture during small wave periods by the effect of their siphons in dimpling the bottom. As the sand accretes, the clams become a surface seeking cobble. During erosion event those now exposed shells roughen and armor the bottom such that beach foreshore loss and long shore sand transport is diminished. This dynamic also applies to sand bars that flank the mouth of inlets. The heightened and shellfish stabilized bar tends to force the tidal flow through the channel such that scouring increases and maintains the channel depth. This dynamic may be enhanced by selective shellfish harvest in the channel. This dynamic also applies to channel growth in the very muddy upper reaches of estuaries. The huge population of clams on the barrier bars and foreshores ,if stewarded by cities like Virginia Beach can extend the tourist season, by means of enhanced surf fishing and by means of a public clamming festival. The convergence of many diverse interests on this invention makes such a festival likely. Such a festival would also serve to build the market for clams by building a huge number of cherished moments whose memory is indelibly linked with the smell of fresh clams. This huge population of clams can nearly eliminate the short hop between channel dredging and beach replenishment in some places. This is a great economic benefit and the ecological benefit. That desirable outcome of this integrated system can be aided by a below inlet channel array of foils to continue long-shore sand transport underneath the inlet channel. When Spisula, Mercenaria and Rangia clams fully populate their niches in the estuary the fine sediment raised in erosion events will be rapidly captured over the whole of the estuary rather than slowly and in just the upper reaches and deeps. In the lower reaches the drifting coarse sands will be made more cohesive and be stabilized by the fine sediment captured by the clams. Those sand drifts will then dramatically slow their drift and become home to greater biomass of more species since the community will have more time to mature. Sea grass will be able spout without being promptly smothered or eroded out of the bottom. Much of the fine sediment captured in the clam pseudo feces will become a near permanent part of the estuary soil. That fine sediment addition adds to nutrient holding capacity of that soil and improves that coarser soil's ability to support life and develop its community.

In the balance between upper and lower estuary, the fluffy and cyclically eroding fine sediments of the upper reaches will have part of their bulk diminished by the clam instigated fine sediment capture in the lower reaches. The reduced proportion of fine sediment will improve the density and stability of the remainder. Moreover the exposed sand of that remainder and recently grown shell will tend to form something of a cobble over the bottom reducing its erosion rate during erosion events. The exposed shell of predator eaten clams will also provide scarce cultch for oyster set and the combined filtering of the huge number of clams will diminish the mud coat that prevents oyster spat set and survival. The resulting oyster growth will roughen the bottom further reducing the erosion rate during erosion events. Between that large reduction in sediment resuspension and large increase in sediment clearance sub-aquatic vegetation can return for a further reduction in sediment resuspension. The resulting water clarity and high level of biomass will allow for nearly complete utilization of the nutrient and sunlight inputs to the estuary. The mass of shellfish growth and subsequent sustainable harvest will provide a proportionally significant sink for our fixed nitrogen inputs. This fuller capture and tight recycling of fixed nitrogen when combined with good water clarity and high standing stocks of sub-aquatic vegetation will trigger the sub aquatic vegetations' strategy for coping with nitrogen limitation by exuding calcium-binding-sulfated-polysaccharides to create a mucus net to gather the nitrogen rich bacteria and ultra plankton into packets that are sufficiently large for the clams and oysters to feed upon. This also increases the nutritional competence of the shellfish in that their export of mucus in feces and pseudo feces is offset by the mucus contribution of the sub aquatic vegetation. This exudate is particularly valuable in instances of high turbidity where the higher pseudo-feces production rate can become so taxing that the shellfish stop their filter feeding. The presence of the exudates thereby reduces the duration turbidity events and makes the events less taxing on the whole community of species. In that the shellfish excrete their nitrogen enriched feces by the roots of the sub aquatic vegetation the sub-aquatic vegetation is “paid” for its exudate. Without the association of clams and oysters the sub-aquatic vegetation's exudate strategy will not be profitable and the sub-aquatic vegetation will display the “wasting disease”. There is some evidence that “wasting disease” prompted declines in sea grass are subsequent to periods of human underemployment with consequential increases in clam harvest effort.

Shrimp will prosper on the banquet of shell fish excrement and release much of the excreta-bound sulfated-polysaccharide for refractory recycle in the oxic zone (as opposed to sulfate reduction/respiration which initiates a host of problems for the clams and oysters) and also provide hygiene service to the shellfish and the seagrass. The shellfish feces mucus that the shrimp recycle into the oxic zone (where the mucus is fairly refractory) enables the Zostera that contributed the mucus to get paid for their contribution as many times as the mucus gets recycled. In the absence of mucus recycling in the oxic zone the nitrate rich pseudo-feces and feces will become suboxic and bacteria, in their metabolization of food, will use the nitrate as an electron accepter as a substitute for the higher energy yielding oxygen. The nutrient nitrate will be decomposed into the non-nutrient di-nitrogen molecule. This is a viable and cost effective way of remediating nitrate pollution. Rangia clams and other fresh water tolerant clams may be utilized for this purpose with the additional benefit of reducing the flux of fine sediment in destructive motion at an estuaries turbidity maximum.

The biological and geochemical contribution of shrimp to bivalve nutritional, hygiene and immune competence is very logical, backed by observation, and is may be made proportionally significant by the use of the BC-Vessel hatchery for shrimp production. Much of the spawner sanctuaries cohort of guild species is quite likely to be spawned with the target species whether intended of not. Given the large scale and low cost this is a good thing and further enables claim 2 and3.

Reaching the ten thousand pounds sustainable harvest per acre/year sunlight constraint disclosed by PCT/US203/003997 is further advanced by this invention.

The cultural instability of the prior art, addressed by the disclosures of PCT/US203/003997, is even more avoided by this invention than by PCT/US203/003997.

The economic incentive for nursery culture that exists in the prior art, addressed by the disclosures of PCT/US203/003997, are even much more avoided by this invention than by PCT/US203/003997.

The constraints that argue for small capacity land based hatcheries such as are seen in the prior art, addressed by the disclosures of PCT/US203/003997, are even much more avoided by this invention than by PCT/US203/003997.

In traditional bivalve hatchery culture the breeding stock is removed from their natural environment and placed in a pool where the hatchery staff provide food, and maintain water quality. This is risky, stressful and expensive for both the shellfish and the hatchery. The rigors of this traditional culture do not feasibly scale up as is needed to achieve the requisite ecosystem scale needed for environmental restoration.

While the present invention is described in connection with what is presently considered to be the most practical and preferred embodiments, it is to be understood that the invention is not limited to the disclosed embodiments, but is intended to cover the various modifications and equivalent arrangements included within the spirit and scope of the claims.

### DESCRIPTION RELATION OF PRIOR ART TO CLAIMS

CLAIM 2 and CLAIM 3 have not been realizable prior to the apparatus of CLAIM 1. Many have tried, including the inventor, but none in the prior art have succeeded in restoring the marine ecosystem's past wealth as displayed in the fossil record. In the prior art, such an undertaking was barely conceivable or was considered laughable in that none could imagine that any cultural intervention that might result in a 99.9% mortality could be of such a large scale and such low cost that it could be could counted an economic success. The most biting derision came from those who wanted stability in the price of shellfish more than they wanted the health of the marine ecosystem.

The enhanced design algorithm, which is patentable in that it is a “new and innovative methods of applying skill or knowledge provided they produced effects or results commercially useful to the public”, is not presented as Claim 5, since it is the desire of the inventor that the algorithm become widely used as a method of receiving valuable knowledge from all species and applying that knowledge in the most useful fashion.

The enhanced algorithm came up with the surprising result that the risks and costs of the prior art, including PCT/US203/003997, could be avoided by making the hatchery cultural intervention less intensive and more extensive which is contrary to the teaching and trend of the prior art, including PCT/US203/003997. The unrecognized costs and risks of that prior art are newly avoided such that now the most economical way to raise the quantity of shellfish required by the market is to raise the much larger quantity of shellfish required to restore the health and productivity of our waters.

The terra-forming uses claimed in PCT/US203/003997 were abandoned by this inventor because physical and financial impossibility creates an absence of industrial utility. That industrial utility is no longer impossible given the scalability of the BC-Vessel and has great value as an intermediate product to that of CLAIM 2 in that dredging and beach replenishment are expensive disruptions of community succession and kill much of the biomass in the affected areas.

CLAIM 1 is made much more vendible by the presence of CLAIM 2 and CLAIM 3. CLAIM 2 and CLAIM 3 are both completely unenforceable and vain efforts in the absence of CLAIM 1. CLAIM 2 and 3 are vendible products to governments having appropriate jurisdictions or large shellfish lease holding associations and those products have substantial economic results.

### BRIEF DESCRIPTION OF SEVERAL VIEWS OF THE INVENTION

The invention will now be described by way of example and with reference to the accompanying drawings in which:

(1) FIG. 1) Plan view of the BC-Vessel

(2) FIG. 2) Cross section of the BC-Vessel in culture mode

(3) FIG. 3) Cross section of the BC-Vessel in larval transport mode

(4) FIG. 4) BC-Vessel sidewall detail cross section
(A) Membrane
(B) Ballast
(C) Floatation
(D) Air line

(5) FIG. 5) Outside Vessel Filter
(A) Filter Bag in Backflush mode
(B) Filter Bag in intake mode

(6) FIG. 6) BC-Vessel sidewall detail cross section showing pleat at low tide
(A) Membrane
(B) Ballast
(C) Floatation

In FIG. 1) the BC-Vessel, as deployed in the water, is shown from above where only the floatation rim is showing above the water.

In FIG.2) the cross section of the BC-Vessel in culture mode were the bottom of the BC-Vessel is opened and the bottom edge secured to the water's sediment bottom such that the shellfish breeding stock is contained.

In FIG.3) the cross section of the BC-Vessel in larval transport mode where the bottom edges of the BC-Vessel wall are brought together and attached to each other so that the contained cultured water and larvae therein can be transported in the BC-Vessel to the location appropriate for their distribution.

In FIG.4) the BC-Vessel sidewall detail cross section is shown revealing the construction details where the (A) Membrane is secured to the water's sediment bottom by means of (B) Ballast, and the (A) Membrane is secured to the water's surface by means of (C) Floatation; and where that floatation is inflated or deflated as need be by an (D) Air line inserted into a sleeve glued to the membrane, extending from the ballasted edge and into the floatation such that an excess pressure bursting of the floatation can be avoided by air escape down the sleeve.

In FIG.5) the Outside Vessel Filter is shown with its housing matching the diameter of the bag filters so that a backflush is enabled. (A) Shows the Filter Bag in Backflush mode and (B) shows the Filter Bag in intake mode.

In FIG.6) BC-Vessel sidewall detail cross section showing the alternative of pleats created by battens on the (A) Membrane of (B) Ballast and (C) Floatation.

### Declarations & Small Entity Election

I, Russell Patton Davis, am the sole inventor of this “INTEGRATED SYSTEM FOR SHELLFISH PRODUCTION AND UTILIZATION#2”. The contents herein are true to the best of my knowledge and belief. No USA Government Agency has any ownership interest in this patent and any other interest that may come to exist is of a gift nature and not an equitable interest. The inventor is not represented by any lawyer or agent in this application. The applicant is a small entity under the rules of the PTO. Signed & Dated:______

Inventor Residence and Correspondence Address: Russell P Davis, 1521 Quail Point Rd., Virginia Beach, Va. 23454 USA

What is claimed is:

1. A process apparatus that is a water-supported live-well vessel characterized by 1) a membrane which bounds the well's contents from the surrounding water; 2) a top rim, supporting the membrane and fit to establish an elevation of that rim as needed to manage the separation between the contents of the live-well vessel and the surrounding water, and have that separation made further manageable by 3) the unique feature in that the bottom of the vessel maybe :A) opened expansively as needed to encompass large quantities of benthic shellfish breeding stock for in-situ spawn induction, B) opened expansively as needed to utilize the water's column's bottom as the BC-Vessel containment bottom for much expanded cultured water capacity while being able to adjust its proportions as needed to accommodate cyclical variations in water level.

2. A water-supported live-well vessel according to claim 1 that has the separation of the contained cultured water from the surrounding water made further manageable by the unique feature in that the bottom of the vessel maybe closed as needed to transport the vast quantity of cultured young for distribution.

3. The newly realizable, therefore newly utilitarian and vendible, product of coastal scaled coastal ecosystem and econosystem restoration by the process of comprehensive ecosystem scaled repopulation as enabled and according to by the novel economy and effectiveness in the claim 1 process apparatus of ecosystem-scalable shellfish hatchery production with early release so that the swarm of shellfish young is so large and so dispersed that the shellfish predators can eat till they are stuffed and there is still a high enough survival rate that the strategy is economically attractive; the comprehensiveness of this product is achieved by using the claim 1 process device in assisting the natural process of species community succession by enabling predicate or guild species to overcome reproductive success hurdles that may not, under current circumstances, be readily overcome by predicate or guild species if not so assisted.

4. An intermediate product, now realizable because of the BC-Vessel (claim 1), therefore newly utilitarian, the terra-forming results of shellfish culture that must, in some locations, substantially supplant dredging, beach replenishment, and foreshore erosion defenses, for the product of claim 3 to be realizable.

5. A process of culturing shellfish so as to aid their reproductive success comprising the steps of A) encompassing shellfish breeding stock for in-situ spawn induction, B) culturing the water above and containing that in-situ breeding stock as needed to advance breeding stock gonad development and trigger a cascade of synchronized spawning, C) further expanding the containment, utilizing the bottom of the water body as one bound, to encompass as much water as is needed to needed to culture the water containing the shellfish spawn.

6. A process according to claim 5 where the separation of the contained cultured water from the surrounding water is made further manageable by contracting the expanse of cultured water until the containment can be closed on the bottom and the containment moved so as to transport the shellfish larvae to the area targeted for repopulation.
